(19) United States
(12) Patent Application Publication
(10) Pub. No.: US 2013/0131871 A1
(43) Pub. Date: May 23, 2013

(54) METHODS AND SYSTEMS FOR DETERMINING HEATING AND AIR CONDITIONING DEMANDS ON A PRINT SHOP

(71) Applicants: Sudhendu Rai, Fairport, NY (US); Marc Dennis Daniels, Webster, NY (US); Craig Charles Lambrecht, Rochester, NY (US)

(72) Inventors: Sudhendu Rai, Fairport, NY (US); Marc Dennis Daniels, Webster, NY (US); Craig Charles Lambrecht, Rochester, NY (US)

(73) Assignee: XEROX CORPORATION, Norwalk, CT (US)

(21) Appl. No.: 13/300,216

(22) Filed: Nov. 18, 2011

(51) Int. Cl. G05D 23/19; G06F 17/10

(52) U.S. Cl. 700/276; 703/2

(57) ABSTRACT

A method of estimating heat emissions for a print shop may include determining a total heat generation value associated with a print shop over the period of time by summing a non-print production heat generation value associated with the print shop over the period of time and a print production heat generation value associated with the print shop over the period of time, determining, by a computing device, a net heat emission value associated with the print shop over the period of time by reducing the total heat generation value by a heat loss rate, and displaying one or more of the non-print production heat generation value, the print production heat generation value, the total heat generation value, and the net heat emission value.

### CROSS REFERENCE TO RELATED APPLICATIONS

This application is related to U.S. patent application Ser. No. 13/300,126 filed on Nov. 18, 2011.

### BACKGROUND

The operation of print devices is often strongly dependent on the atmosphere of the operating environment. For example, a high humidity environment can lead to excessive paper jams. Similarly, print quality often decreases in response to variations in temperature and humidity. Heat generated by the operation of print devices in a print shop is typically offset by air conditioning to maintain acceptable paper handling and print performance conditions.

Adequate air conditioning capacity in a print shop is important so that the print shop has an appropriate temperature and humidity to generate optimal performance. Currently, estimation of air conditioning capacity is performed using ad-hoc estimation to approximate heat generation from print devices and determine air conditioning requirements. However, this approach often leads to over-estimates on the air-conditioning requirement. For large print shops, these overestimates can be significant because such shops typically use a significant amount of equipment that generate a significant amount of heat.

Examination of a facility's utility usage may provide clues as to the effects of the heat generated. But there are no convenient methods of separating the effects of heat generation due to print production equipment. In addition, estimates of air conditioning requirements are important to consider in making upgrades to a facility, choosing a facility or outsourcing work.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of estimating heat emissions for a print shop may include determining a total heat generation value associated with a print shop over the period of time by summing a non-print production heat generation value associated with the print shop over the period of time and a print production heat generation value associated with the print shop over the period of time, determining, by a computing device, a net heat emission value associated with the print shop over the period of time by reducing the total heat generation value by a heat loss rate, and displaying one or more of the non-print production heat generation value, the print production heat generation value, the total heat generation value, and the net heat emission value.

In an embodiment, a system for estimating heat emissions for a print shop may include a computing device and a computer-readable storage medium in communication with the computing device. The computer-readable storage medium may include one or more programming instructions that, when executed, cause the computing device to determine a total heat generation value associated with a print shop over the period of time by summing a non-print production heat generation value associated with the print shop over the period of time and a print production heat generation value associated with the print shop over the period of time, determine a net heat emission value associated with the print shop over the period of time by reducing the total heat generation value by a heat loss rate, and display one or more of the non-print production heat generation value, the print production heat generation value, the total heat generation value, and the net heat emission value.

### BRIEF DESCRIPTION OF THE DRAWINGS

FIGS. 1 and 2 each illustrate examples of print shop according to an embodiment.

FIG. 3 illustrates a method of estimating heat emissions for a print shop according to an embodiment.

FIG. 4 illustrates a method of estimating a print production heat emission value according to an embodiment.

FIG. 5A illustrates the layout of a print shop according to an embodiment.

FIG. 5B illustrates a method of determining a heat loss rate according to an embodiment.

FIG. 6 illustrates thermal resistance values as set forth in Table 502.2(1) of the International Energy Conservation Code according to an embodiment.

FIGS. 7 and 8 each illustrate a graph of total heat emissions with respect to time according to embodiments.

FIG. 9 illustrates a graph of air conditioning usage with respect to time according to an embodiment.

FIG. 10 illustrates a block diagram of internal hardware that may be used to contain or implement program instructions according to an embodiment.

### DETAILED DESCRIPTION

The following terms shall have, for purposes of this application, the respective meanings set forth below:

A “print device” refers to a device capable of performing one or more functions, operations and/or services on a print job. For example, a print device may provide print-related services for one or more print jobs. A print device may include a printer, a cutter, a collator, a scanner, a fax machine, a multi-function device or other similar equipment.

A “job” refers to a logical unit of work that is to be completed for a customer. In a print environment, a job may include one or more print jobs from one or more clients.

A “non-print production heat generation value” may be a measurement of the amount of heat generated over a period of time by sources in the print shop other than print devices.

A “print job” refers to a job processed in a print production system. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “print production heat generation value” may be a measurement of the amount of heat generated over a period of time by print devices in a print shop.

A “print shop” refers to an entity that includes a plurality of print devices, such as printers, cutters, collators and the like. A print shop may be a freestanding entity, including one or more print devices, or it may be part of a corporation or other entity. Additionally, a print shop may communicate with one or more servers by way of a communications network, such as the Internet, an intranet, a LAN, a WAN, a wireless network and/or the like.

A “print job function” is an operation, such as printing, binding, collating and/or the like, that is performed on a print job.

“Processing” of a print job means performing one or more print job functions on a print job to transform a print job in some manner and/or result in the display, transmission or conversion of the print job to a physical substrate.

A “low-activity state” refers to a mode of operation of a print device during which the print device does not process a print job. Examples of low-activity states may include an idle mode, a sleep mode, an off mode and/or the like.

A “processing state” refers to a mode of operation of a print device during which the print device process one or more print jobs.

A “low-activity state heat emission value” is the amount of heat utilized by, consumed by, generated by or otherwise associated with a print device when the print device operates in one or more low-activity states.

A “processing state heat emission value” is the amount of heat utilized by, consumed by, generated by or otherwise associated with a print device when the print device operates in a processing state.

A “workflow” is a sequence of operations that are performed to complete a print job.

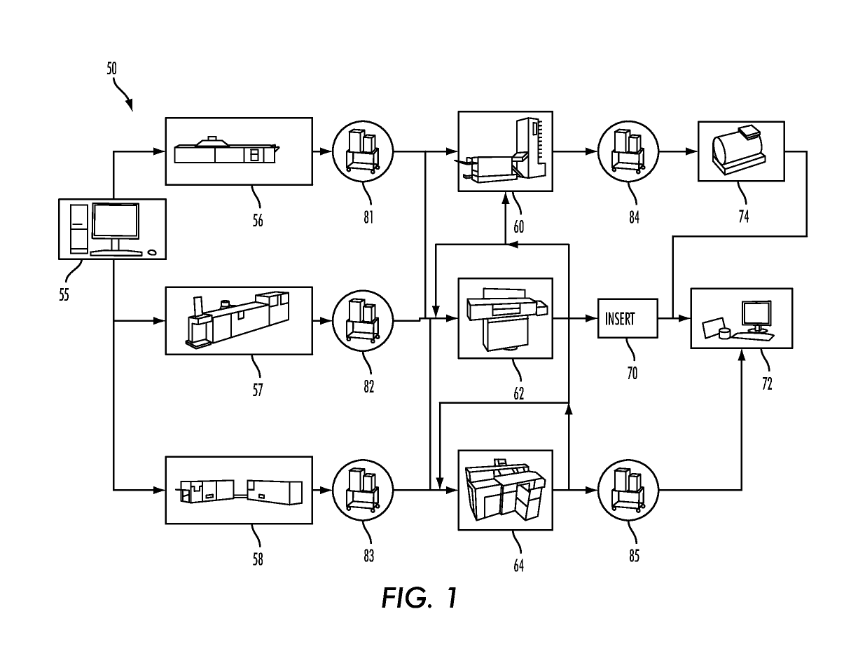

FIG. 1 shows an example of a production environment 50, in this case, examples of elements of a print shop. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85. Although the disclosed embodiments pertain to document production systems, the disclosed methods and systems can be applied to production systems in general.

FIG. 2 illustrates a print shop according to an embodiment. As illustrated by FIG. 2, the print shop 200 includes three printers (Printer 1 205, Printer 2 210 and Printer 3 215), three cutters (Cutter 1 220, Cutter 2 225 and Cutter 3 230) and two collators (Collator 1 235 and Collator 2 240). The print shop illustrated in FIG. 2 will serve as the basis for examples discussed in this application, but it is understood that additional and/or alternate print shops and print shop configurations may be used within the scope of this disclosure.

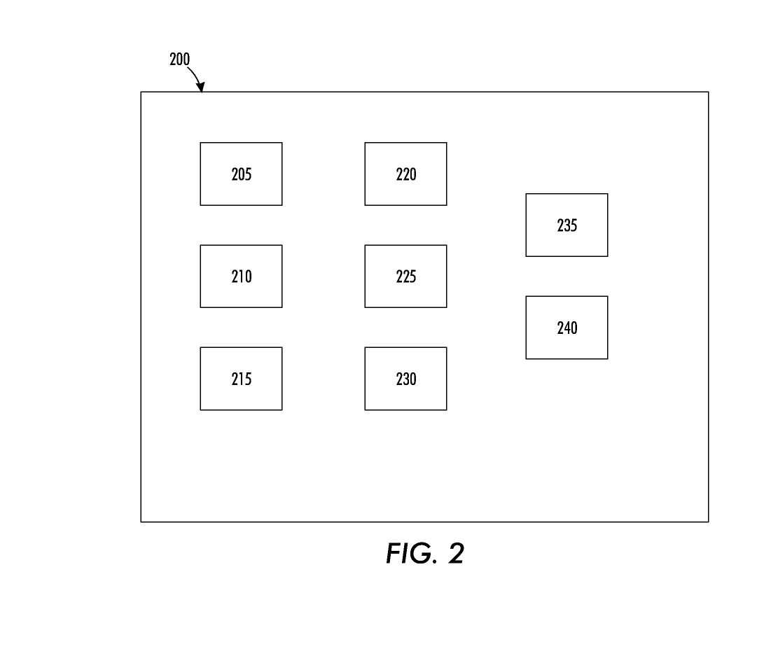

FIG. 3 illustrates a method of estimating heat emissions for a print shop according to an embodiment. As illustrated by FIG. 3, a non-print production heat generation value may be determined 300 for a print shop over a period of time. The non-print production heat generation value may represent the amount of heat generated over the period of time by sources in the print shop other than print devices. Examples of non-print production heat generation sources may include people, light sources and/or other heat generating devices present in the print shop.

For example, an estimate of a total amount of heat generated by people in the print shop over a period of time may be determined 305. This amount may be determined 305 by estimating a total number of people in the print shop over the period of time. In an embodiment, a total number of people in the print shop over the time period may be estimated using a work schedule, shift schedule or other documentation of those working in the print shop. For example, if the time period in question is between 8 a.m. and 5 p.m. on a certain day, a work schedule may be used to identify the number of workers present in the print shop during this time period. In an embodiment, this number may be supplemented by a certain number to account for people who are not scheduled to be in the print shop, but who may temporarily be present in the print shop during the time period.

In an embodiment, a heat generation rate may be determined. The heat generation rate may be an amount of heat generated per person over a period of time. In an embodiment, a heat generation rate may be a certain rate that is uniform across all people. For example, a heat emission rate may be 500 BTU per person per hour. In an alternate embodiment, a heat generation rate may vary from person to person.

In an embodiment, a total amount of heat generated by people in the print shop over the period of time may be determined 305 by multiplying the total number of people in the print shop over the period of time by a heat generation rate. For example, if there are 15 people in the print shop between 8 a.m. and 5 p.m. and the heat generation rate is 500 BTU per person per hour, the total amount of heat generated by people in the print shop between 8 a.m. and 5 p.m. may be estimated as 67,500 BTU (i.e., (500 BTU/person/hour*9 hours)*15 people). In an embodiment, a total number of people in a print shop may be determined by analyzing print shop access records. For example, a person may be required to scan a card or provide an access code to enter a print shop. In an embodiment, a total number of people in a print shop may be estimated.

In an embodiment, an estimate of a total amount of heat generated by light sources in a print shop over a period of time may be determined 310. In an embodiment, an amount of heat generated by a light source in a print shop may be determined by multiplying the heat generation rate of the light source by the time period over which the light source operates within the period of time at issue. In an embodiment, the heat generation rate of a light source and/or the time period over which the light source operates may be determined by retrieving this information from a light source, a database or other storage medium. In an embodiment, a heat generation rate may be provided by a manufacturer of a light source. In an embodiment, a heat generation rate may be experimentally determined.

In an embodiment, a total amount of heat generated by light sources in a print shop over a period of time may be determined 310 by adding the amount of heat generated by each light source in the print shop during the period of time.

In an embodiment, an estimate of a total amount of heat generated by other non-print related devices in a print shop may be determined 315. Examples of non-print related devices may include computers, electric heaters, music players and/or the like. In an embodiment, an amount of heat generated by a non-print related device in a print shop may be determined by multiplying the heat generation rate of the non-print related device by the time period over which the non-print related device operates within the period of time at issue. In an embodiment, the heat generation rate of a non-print related device and/or the time period over which the non-print related device operates may be determined by retrieving this information from a non-print related device, a database or other storage medium. In an embodiment, a total amount of heat generated by non-print related devices in a print shop over a period of time may be determined 315 by adding the amount of heat generated by each non-print related device in the print shop during the period of time.

In an embodiment, a non-print production heat generation value may be determined 300 by adding the total amount of heat generated by people in a print shop over a period of time, the total amount of heat generated by light sources in the print shop over the period of time, and a total amount of heat generated by other non-print related devices in the print shop over the period of time.

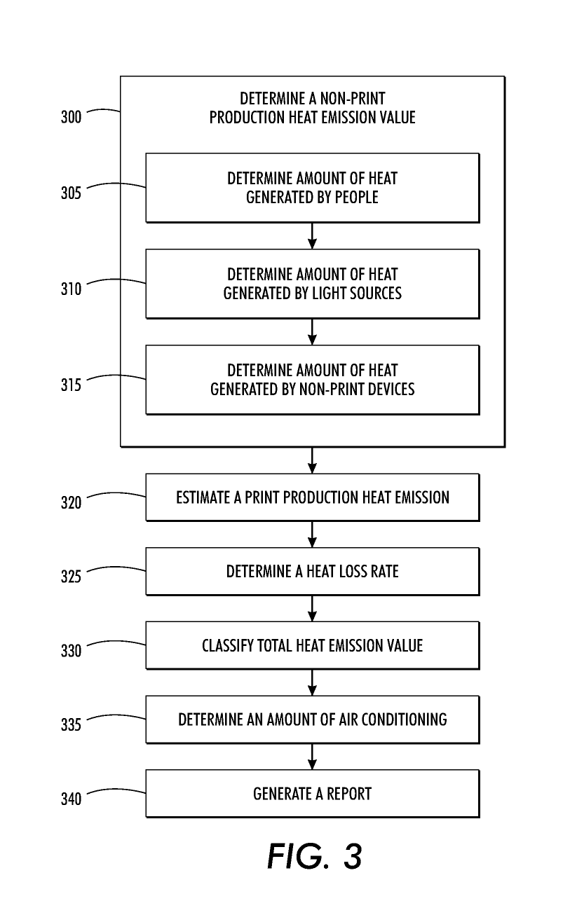

Referring back to FIG. 3, a print production heat generation value may be estimated 320. FIG. 4 illustrates a method of estimating a print production heat generation value according to an embodiment. As illustrated by FIG. 4, a processing state heat generation value associated with one or more print devices in a print shop over a period of time may be determined 400. A processing state heat generation value may be an amount of heat emitted by one or more print devices when each print device operates in a processing state.

In an embodiment, one or more print jobs may be identified 405. In an embodiment, the identified print jobs may be ones that have been processed by a print shop. In an embodiment, the identified print jobs may be ones that have not been processed by a print shop, but for which one or more processing state sustainability metric values associated with processing the identified print jobs by a print shop are to be determined. In an embodiment, one or more print jobs may be identified by receiving information identifying the print jobs from a computing device, a print device, a database and/or the like. This information may include a log associated with one or more print devices and/or the like.

In an embodiment, an identified print job may have an associated workflow. The workflow may specify operations to perform on the print job and the order in which the operations are to be performed. For example, a workflow associated with a print job may indicate that the print job is to be printed, cut and bound.

In an embodiment, one or more batches associated with one or more print jobs may be identified 410. In an embodiment, one or more batches associated with a print job may be identified 410 based on a workflow associated with the print job. A batch may be a smaller-sized subcomponent of a print job. A print job may be split into batches to expedite processing of a print job. For example, batches may be concurrently processed to achieve a higher overall utilization of resources in a print shop and faster turnaround times for print jobs. In an embodiment, a batch may have a corresponding batch size. The batch size may be chosen to decrease the total time it takes a print shop to process the print job.

In an embodiment, one or more print devices in a print shop to which one or more batches are assigned to be processed may be determined 415. For example, each batch may be scheduled, assigned and/or the like to one or more print devices in a print shop. The print devices to which a batch is assigned may be based on the print device's capabilities, availability and/or the like. Methods for determining optimal batch-sizes and scheduling of print jobs are also known in the art and described in, for example, U.S. Pat. Nos. 5,999,758, 7,065,567, 7,051,328, 6,805,502 and 7,542,161, the disclosures of which are incorporated by reference in their entireties.

Table 3 illustrates a table of identified print jobs, batches, batch sizes and assigned print devices of the print shop illustrated in FIG. 2 according to an embodiment.

TABLE 3

| | | Batch Size | Assigned Print |
|---|---|---|---|
| Print Job | Batches | (pages) | Devices |
| Print Job 1 | Batch 1 | 5,000 | Printer 1 |
| | | | Collator 1 |
| | Batch 2 | 7,500 | Printer 2 |
| | | | Collator 2 |
| Print Job 2 | Batch 1 | 3,500 | Printer 1 |
| | | | Cutter 1 |
| | | | Collator 1 |
| | Batch 2 | 3,000 | Printer 2 |
| | | | Cutter 2 |
| | | | Collator 2 |
| | Batch 3 | 2,500 | Printer 3 |
| | | | Cutter 3 |
| | | | Collator 1 |
| Print Job 3 | Batch 1 | 2,700 | Printer 1 |
| | | | Cutter 1 |
| | Batch 2 | 6,600 | Printer 3 |
| | | | Cutter 2 |

In an embodiment, a processing time associated with processing each batch of an identified print job by each assigned print device may be determined 420. For example, referring to Table 3, a processing time associated with processing Print Job 1 may be determined 420 by determining the processing time associated with processing Batch 1 by Printer 1 and Collator 1, and Batch 2 by Printer 2 and Collator 2.

In an embodiment, a processing rate associated with one or more assigned print devices may be determined 425. For example, a processing rate associated with a print device may be retrieved from a database or other storage medium. Table 4 illustrates examples of processing rates associated with the print devices identified in Table 3.

TABLE 4

| Print Device | Processing Rate |
|---|---|
| Printer 1 | 1500 pages/hour |
| Printer 2 | 2100 pages/hour |
| Printer 3 | 1800 pages/hour |
| Cutter 1 | 2500 pages/hour |
| Cutter 2 | 2700 pages/hour |
| Cutter 3 | 2650 pages/hour |
| Collator 1 | 1600 pages/hour |
| Collator 2 | 1700 pages/hour |

In an embodiment, a processing time associated with processing a batch may be determined 430 for each print device to which the batch is assigned. In an embodiment, a processing time associated with processing a batch by a print device may be determined 430 by dividing the batch size of the batch by the processing rate associated with the print device. For example, referring to Tables 3 and 4, a processing time associated with processing Batch 1 of Print Job 1 by Printer 1 may be determined 420 by dividing the processing rate associated with Printer 1 by the batch size of Batch 1 (i.e.,

$$\frac{5 , 000 pages}{1500 pages \text{/} hr} = 3.33 hours ) .$$

Table 5 illustrates examples of processing times for each batch and print job illustrated in Table 3 according to an embodiment.

TABLE 5

| | | | Processing |
|---|---|---|---|
| Print Job | Batches | Print Device | Time (hours) |
| Print Job 1 | Batch 1 | Printer 1 | 3.33 |
| | | Collator 1 | 3.125 |
| | Batch 2 | Printer 2 | 3.57 |
| | | Collator 2 | 4.41 |
| Print Job 2 | Batch 1 | Printer 1 | 2.33 |
| | | Cutter 1 | 1.4 |
| | | Collator 1 | 2.18 |
| | Batch 2 | Printer 2 | 1.42 |
| | | Cutter 2 | 1.11 |
| | | Collator 2 | 1.76 |
| | Batch 3 | Printer 3 | 1.38 |
| | | Cutter 3 | 0.94 |
| | | Collator 1 | 1.56 |
| Print Job 3 | Batch 1 | Printer 1 | 1.8 |
| | | Cutter 1 | 1.08 |
| | Batch 2 | Printer 3 | 3.66 |
| | | Cutter 2 | 2.44 |

In an embodiment, a total processing time associated with processing the identified print jobs may be determined 435 for one or more print devices in a print shop. A total processing time for a print device may be determined 435 by summing the processing times associated with each batch that is assigned to the print device. For example, referring to Table 5, a total processing time associated with Printer 1 may be the sum of the processing times of Print Job 1/Batch 1, Print Job 2/Batch 1 and Print Job 3/Batch 1 (i.e., 3.33+2.33+1.80=7.46 hours). Table 6 illustrates examples of total processing times for the print devices illustrated in Table 4 according to an embodiment.

TABLE 6

| | Total Processing |
|---|---|
| Print Device | Time (hours) |
| Printer 1 | 7.46 |
| Printer 2 | 4.99 |
| Printer 3 | 5.04 |
| Cutter 1 | 2.48 |
| Cutter 2 | 3.55 |
| Cutter 3 | 0.94 |
| Collator 1 | 6.87 |
| Collator 2 | 6.17 |

In an embodiment, one or more processing state heat generation values associated with one or more print devices may be determined 440. The processing state heat generation values may be based on the total processing times associated with one or more print devices over a period of time. In an embodiment, a processing state rate associated with a processing state heat generation value may be determined 445. For example, a processing state rate may be a heat generation rate. In an embodiment, a processing state rate may be specific to a print device, a print device model, a print device type and/or the like. A processing state rate may be determined 445 by retrieving the processing state rate from a database, a print device and/or other storage medium. In an embodiment, a processing state rate may be a rate associated with a print device, a print device type, a print device model and/or the like. In an embodiment, a processing state rate may be an average rate associated with a print device, a print device type, a print device model and/or the like.

In an embodiment, a processing state heat generation value for one or more print devices may be determined 450. For example, a processing state heat generation value may be determined 450 by multiplying the determined processing state rate by the total processing time associated with a print device.

For example, a processing state heat generation value associated with a print device may be determined by multiplying a heat generation rate associated with the print device by the total processing time associated with the print device. For instance, if a heat generation rate associated with Printer 1 of Table 6 is 20 BTU/hour, a processing state power usage associated with Printer 1 during the processing of Print Job 1, Print Job 2 and Print Job 3 may be 149.2 BTUs (i.e., 20 BTU/hour*7.46 hours). Table 7 illustrates examples of processing state heat generation values for the print devices illustrated in FIG. 2 according to an embodiment.

TABLE 7
Processing State

| | Total Processing | Heat Generation | Total Heat |
|---|---|---|---|
| Print Device | Time (hours) | Rate (BTU/hour) | Generated (BTU) |
| Printer 1 | 7.46 | 1537.8 | 11471.99 |
| Printer 2 | 4.99 | 1435.6 | 7163.64 |
| Printer 3 | 5.04 | 1502.3 | 7571.59 |
| Cutter 1 | 2.48 | 1278.4 | 3170.43 |
| Cutter 2 | 3.55 | 1304.2 | 4629.91 |
| Cutter 3 | 0.94 | 1281.0 | 1204.14 |
| Collator 1 | 6.87 | 1002.9 | 6889.92 |
| Collator 2 | 6.17 | 1175.2 | 7250.98 |

In an embodiment, a low-activity state heat generation value associated with one or more print devices in a print shop over a period of time may be determined 455. In an embodiment, a low-activity state heat generation value associated with a print device may determined by analyzing a schedule associated with the print shop. In an embodiment, a schedule may reflect one or more periods of time when a print device is operating in a processing state and/or one or more periods of time when the print device is operating in a low-activity state.

For example, a schedule for the print shop illustrated in FIG. 2 may show that the print shop operates between the hours of 8 a.m. and 5 p.m. The schedule may show that during this time, the print shop processed Print Job 1, Print Job 2 and Print Job 3. The schedule may show that for the period of time between 8 a.m. and 5 p.m. each print device in the print shop was operating in idle mode if it was not processing Print Job 1, Print Job 2 or Print Job 3. In an embodiment, the schedule may show that during the period from 5 p.m. to 8 a.m. the print devices in the print shop operated in sleep mode.

In an embodiment, an amount of time that one or more print devices in a print shop operate in a low-activity state may be determined 460. For example, an amount of time that a print device operated in each of an idle mode, a sleep mode and an off mode may be determined 460 based on an associated schedule.

For example, the schedule for the print shop of FIG. 2 may indicate that the print shop only processed Print Job 1, Print Job 2 and Print Job 3 in a 24-hour period of time. As such, during the period of time between 8 a.m. and 5 p.m. if a device in the print shop was not processing Print Job 1, Print Job 2 or Print Job 3, then such device was operating in an idle mode. A total time each print device operated in idle mode may be determined by determining the difference between the time the print shop operates (i.e., between 8 a.m. and 5 p.m) and the processing time associated with the print device for processing Print Job 1, Print Job 2 and Print Job 3 (i.e., Table 6). For example, the print shop illustrated in FIG. 2 operates for 9 hours in a 24-hour period. As such, the amount of time that Printer 1 is idle between 8 a.m. and 5 p.m is equal to the difference between the total operating time of the print shop and the total processing time of Printer 1 (i.e., 9 hours−7.46 hours=1.54 hours).

Similarly, an amount of time that one or more print devices spends in other low-activity states may be determined. For example, an amount of time that a print device operates in sleep mode or is powered off may be determined. For instance, the schedule associated with the print shop illustrated in FIG. 2 may indicate that all of the print devices in the print shop operate in sleep mode between the hours of 5 p.m. and 8 a.m. As such, each print device in the print shop operates in sleep mode for 15 hours. Table 8 illustrates examples of low-activity state times associated with the print devices shown in FIG. 2.

TABLE 8

| | Total Time - | Total Time - | Total Time - |
|---|---|---|---|
| | Idle Mode | Sleep Mode | Off |
| Print Device | (hours) | (hours) | (hours) |
| Printer 1 | 1.54 | 15 | 0 |
| Printer 2 | 4.01 | 15 | 0 |
| Printer 3 | 3.96 | 15 | 0 |
| Cutter 1 | 6.52 | 15 | 0 |
| Cutter 2 | 5.45 | 15 | 0 |
| Cutter 3 | 8.06 | 15 | 0 |
| Collator 1 | 2.14 | 15 | 0 |
| Collator 2 | 2.83 | 15 | 0 |

In an embodiment, one or more low-activity state heat generation values associated with one or more print devices may be determined 465. The low-activity state heat generation values may be based on one or more low-activity state operating times associated with one or more print devices over a period of time. In an embodiment, a low-activity state rate associated with a low-activity state heat generation value may be determined 470. For example, a low-activity state rate may be a heat generation rate. For example, an idle rate may be a low-activity state rate associated with a low-activity state metric corresponding to a print device operating in idle mode. Similarly, a sleep rate may be a low-activity state rate associated with a low-activity state metric corresponding to a print device operating in sleep mode, and an off rate may be a low-activity state rate associated with a low-activity state metric corresponding to a print device operating in off mode.

In an embodiment, a low-activity state rate may be specific to a print device, a print device model, a print device type and/or the like. A low-activity state rate may be determined 470 by retrieving the rate from a database or other storage medium. In an embodiment, a low-activity state sustainability metric may be determined by multiplying the determined low-activity state rate by the low-activity state operating time associated with a print device.

In an embodiment, a total low-activity state heat generation value may be determined 475 by a print device by summing the low-activity state heat generation values for each low-activity state in which the print device operates. For example, a total low-activity state heat generation value may be determined 475 by summing the heat generation values associated with the print device operating in an idle mode, a sleep mode and/or an off mode.

For example, a low-activity state heat generation value associated with a print device may be determined for one or more low-activity states, such as an idle mode, a sleep mode, an off mode and/or the like. A low-activity state power usage may be determined by multiplying a heat generation rate for a print device operating in a low-activity state by the amount of time the print devices operates in that low-activity state. For instance, if a heat generation rate associated with Printer 1 when it operates in idle mode is 429.7 BTUs/hour, a low-activity state heat generation value associated with Printer 1 when Printer 1 operates in idle mode during the processing of Print Job 1, Print Job 2 and Print Job 3 may be 661.74 BTUs (i.e., 429.7 BTUs/hour*1.54 hours). If a low-activity state heat generation value associated with Printer 1 when it operates in sleep mode is 137.2 BTU, and a low-activity state heat generation value associated with Printer 1 when it operates in off mode is 0 BTUs, a total low-activity state power usage associated with Printer 1 may be 2719.74 BTUs (661.74+15 (137.2)+0). Table 9 illustrates examples of low-activity state power usages for the print devices illustrated in FIG. 2 according to an embodiment.

TABLE 9
Low-activity State Heat Generation Values (BTUs)

| | Idle | | | Sleep | | | Off | | |
|---|---|---|---|---|---|---|---|---|---|
| | Idle Heat | | Idle Heat | Sleep Heat | | Sleep Heat | Off Heat | | Off |
| | Generation | Idle | Generation | Generation | Sleep | Generation | Generation | Off | Heat |
| Print | Rate | Time | Value | Rate | Time | Value | Rate | Time | Usage |
| Device | (BTU/hour) | (hour) | (BTU) | (BTU/hour) | (hour) | (BTU) | (BTU/hour) | (hour) | (BTU) |
| Printer 1 | 429.7 | 1.54 | 661.74 | 137.2 | 15 | 2058 | 0.00 | 0 | 0 |
| Printer 2 | 414.3 | 4.01 | 1661.34 | 130.8 | 15 | 1962 | 0.00 | 0 | 0 |
| Printer 3 | 432.7 | 3.96 | 1713.49 | 134.7 | 15 | 2020.5 | 0.00 | 0 | 0 |
| Cutter 1 | 323.4 | 6.52 | 2108.57 | 104.9 | 15 | 1573.5 | 0.00 | 0 | 0 |
| Cutter 2 | 304.7 | 5.45 | 1660.62 | 112.6 | 15 | 1689 | 0.00 | 0 | 0 |
| Cutter 3 | 310.6 | 8.06 | 2503.44 | 134.7 | 15 | 2020.5 | 0.00 | 0 | 0 |
| Collator 1 | 178.4 | 2.14 | 381.78 | 102.5 | 15 | 1537.5 | 0.00 | 0 | 0 |
| Collator 2 | 198.5 | 2.83 | 561.76 | 111.3 | 15 | 1669.5 | 0.00 | 0 | 0 |

In an embodiment, a total heat generation value may be determined 480 for one or more print devices in a print shop. A total heat generation value may be the sum of the total low-activity state heat emission value and the total processing state heat generation value associated with a print device. For example, a total heat generation value associated with Printer 1 as illustrated in FIG. 2 may be the sum of the low-activity state heat generation value associated with Printer 1 and the processing state heat generation value associated with Printer 1. Table 10 illustrates examples of total heat generation values associated with the print devices illustrated in FIG. 2 according to an embodiment.

TABLE 10

| | Heat Generation (BTUs) | | |
|---|---|---|---|
| Print | Low-activity | Processing | |
| Device | State | State | Total |
| Printer 1 | 2719.74 | 11471.99 | 14191.73 |
| Printer 2 | 3623.34 | 7163.64 | 10786.98 |
| Printer 3 | 3733.99 | 7571.59 | 11305.58 |
| Cutter 1 | 3682.07 | 3170.43 | 6852.5 |
| Cutter 2 | 3349.62 | 4629.91 | 7979.53 |
| Cutter 3 | 4523.94 | 1204.14 | 5728.08 |
| Collator 1 | 1919.28 | 6889.92 | 8809.2 |
| Collator 2 | 2231.26 | 7250.98 | 9482.24 |
| Print Shop Total | 25783.24 | 49352.6 | 75,135.84 |

In an embodiment, a total print production heat generation value may be determined 485 for a print shop. A total print production heat generation value may be determined 485 by summing the total heat generation values associated with each print device in the print shop. Table 13 illustrates total heat generation values and a print production heat emission value for the print shop illustrated in FIG. 2 according to an embodiment.

In an embodiment, a total heat generation value may be determined 490 for a print shop over a period of time. In an embodiment, a total heat generation value may be determined 490 by summing the non-print production heat generation value and the print production heat generation value. Table 11 illustrates examples of total heat generation values of a print shop for each day in November according to an embodiment.

TABLE 11

| | Total Heat Generation |
|---|---|
| November | Value (BTU) |
| 1 | 110,425.78 |
| 2 | 115,983.43 |
| 3 | 127,126.12 |
| 4 | 104,548.32 |
| 5 | 119,932.10 |
| 6 | 108,004.67 |
| 7 | 122,763.56 |
| 8 | 111,998.30 |
| 9 | 123,908.43 |
| 10 | 117,632.76 |
| 11 | 113,665.44 |
| 12 | 132,890.32 |
| 13 | 125,489.21 |
| 14 | 109,890.31 |
| 15 | 114,908.08 |
| 16 | 135,887.60 |
| 17 | 111,987.54 |
| 18 | 112,094.10 |
| 19 | 107,654.00 |
| 20 | 110,543.09 |
| 21 | 117,654.43 |
| 22 | 121,908.12 |
| 23 | 116,876.10 |
| 24 | 121,087.75 |
| 25 | 116,432.90 |
| 26 | 109,832.10 |
| 27 | 118,762.08 |
| 28 | 104,321.87 |
| 29 | 111,345.10 |
| 30 | 131,209.83 |

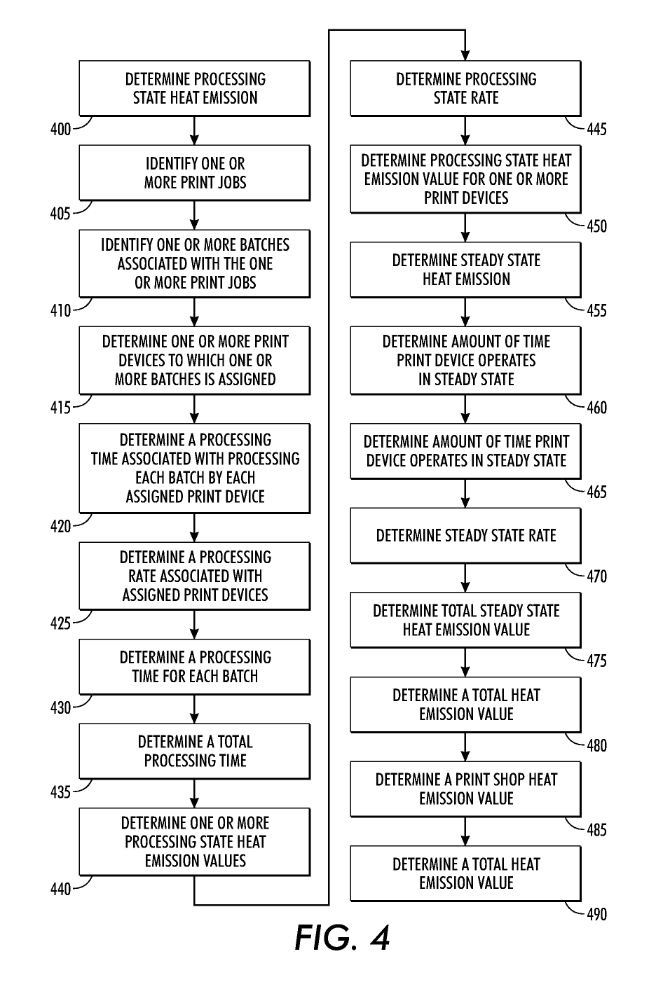

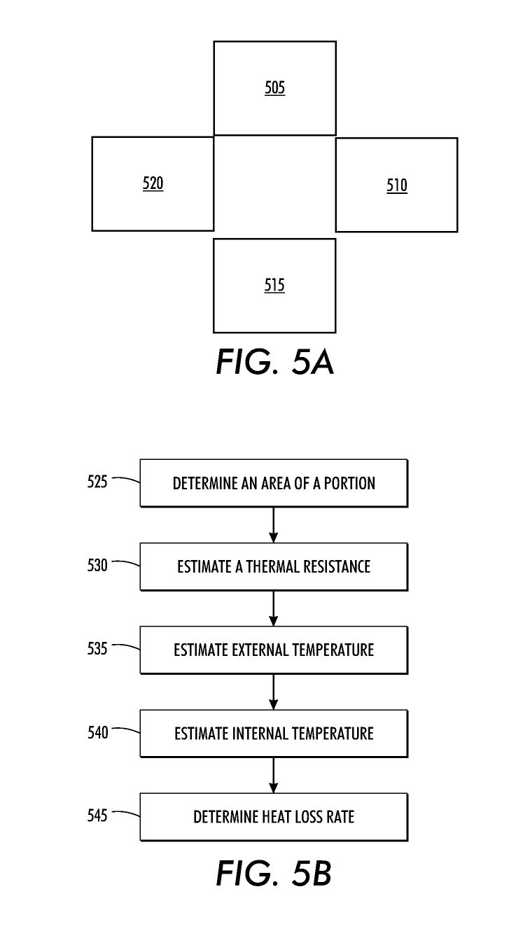

In an embodiment, an amount of heat loss through the print shop over a period of time may be determined. FIG. 5B illustrates a method of determining a heat loss rate according to an embodiment. In an embodiment, a heat loss rate of a print shop over a period of time may be represented by the following:

$$P = ( \frac{{A}_{1}}{{R}_{1}} + \frac{{A}_{2}}{{R}_{2}} + … \frac{{A}_{n}}{{R}_{n}} ) * Δ t , where$$

P=heat loss rate
A=area of portion of print shop
R=thermal resistance
Δt=temperature difference between the inside and outside temperatures

In an embodiment, a print shop may be comprised of one or more distinct portions, such as rooms, buildings, hallways and/or the like. Each portion may have its own area. For example, FIG. 5A illustrates the layout of a print shop. As illustrated by FIG. 5A, a print shop may have four distinct portions 505, 510, 515, 520, and each portion may have a corresponding area.

In an embodiment, the area of one or more portions of a print shop may be determined 525. In an embodiment, an area of a portion of a print shop may be determined 525 from a schematic diagram, a map or other depiction of the layout of a print shop. In an embodiment, an area of a portion of a print shop may be retrieved from a computing device, a database or other storage medium. Table 12 illustrates areas of the print shop portions illustrated in FIG. 5A.

TABLE 12

| Portion | Area (sq. feet) |
|---|---|
| Portion 1 | 8,750 |
| Portion 2 | 7,000 |
| Portion 3 | 8,750 |
| Portion 4 | 7,000 |

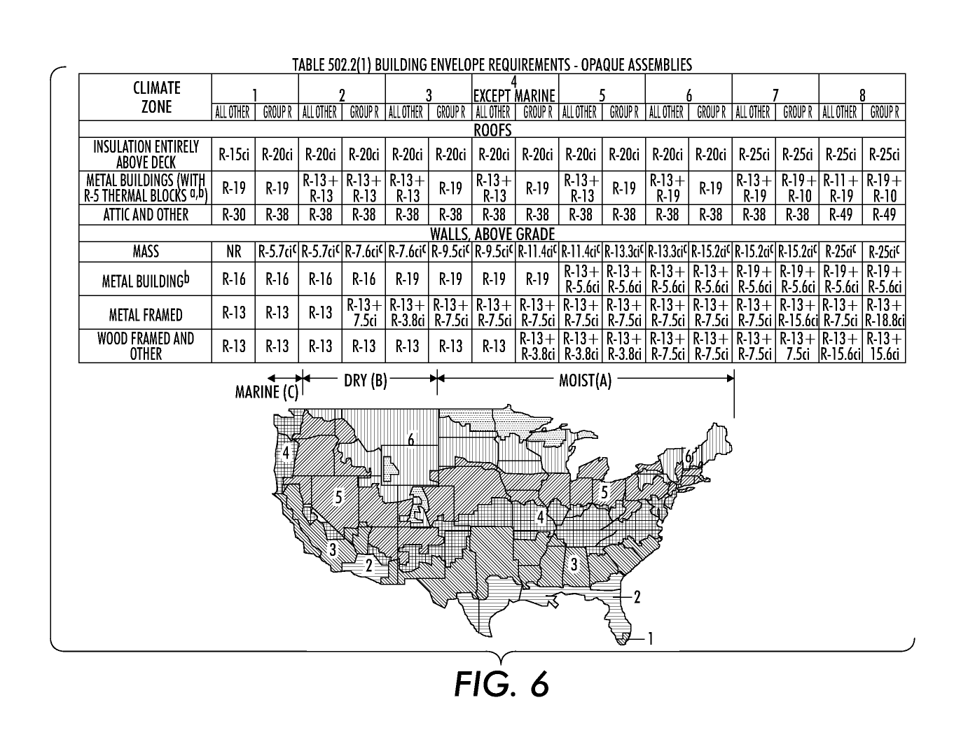

In an embodiment, the thermal resistance associated with one or more portions of the print shop may be estimated 530. The thermal resistance may represent the thickness of a particular material divided by the material's thermal conductivity. In an embodiment, a thermal resistance value for one or more portions of a print shop may be estimated 530 by retrieving one or more estimated values from a computing device, database or other storage medium. In an embodiment, a thermal resistance value may be estimated 530 using building regulations, government standards and/or the like. For example, FIG. 6 illustrates examples of thermal resistance values as set forth in Table 502.2(1) of the International Energy Conservation Code. Table 13 illustrates examples of thermal resistance values for the print shop portions illustrated in Table 12.

TABLE 13

| | | Thermal Resistance |
|---|---|---|
| Portion | Area (sq. feet) | (R-Value) |
| Portion 1 | 8,750 | 12.05 |
| Portion 2 | 7,000 | 10.83 |
| Portion 3 | 8,750 | 12.02 |
| Portion 4 | 7,000 | 10.90 |

In an embodiment, an outside temperature of the print shop's location may be estimated 535 over the period of time. For example, if the period of time is the month of November of a particular year, a daily temperature may be estimated 535 for each day in November at the print shop's location. In an embodiment, a daily temperature may be an average temperature, a low temperature, a high temperature and/or the like.

In an embodiment, historical temperature data may be used to estimate 535 an outside temperature on a particular day or over a particular period of time. For example, to estimate a daily temperature for each day of November, historical temperature data from one or more previous Novembers at the print shop location may be used. In an embodiment, a previous year's temperatures for the period of time may be used. In an alternate embodiment, the temperatures for a past period of time may be averaged to estimate the temperatures over the period of time. For example, to estimate the temperature for a day in November, the temperatures on the same day for the past three years may be averaged. Table 14 illustrates examples of daily high temperatures for the month of November for a print shop located in Minneapolis, Minn. according to an embodiment.

TABLE 14

| | Outside |
|---|---|
| November | Temp (° F.) |
| 1 | 40 |
| 2 | 41 |
| 3 | 39 |
| 4 | 42 |
| 5 | 37 |
| 6 | 38 |
| 7 | 35 |
| 8 | 39 |
| 9 | 38 |
| 10 | 38 |
| 11 | 35 |
| 12 | 37 |
| 13 | 36 |
| 14 | 39 |
| 15 | 34 |
| 16 | 35 |
| 17 | 35 |
| 18 | 33 |
| 19 | 34 |
| 20 | 33 |
| 21 | 32 |
| 22 | 30 |
| 23 | 32 |
| 24 | 34 |
| 25 | 33 |
| 26 | 34 |
| 27 | 32 |
| 28 | 30 |
| 29 | 28 |
| 30 | 32 |

In an embodiment, a temperature inside a print shop may be estimated 540 over the period of time. In an embodiment, historical temperature data may be used to estimate 540 a print shop temperature on a particular day or over a particular period of time. For example, to estimate a daily temperature for each day of November, historical temperature data from one or more previous Novembers in the print shop may be used. In an embodiment, a previous year's temperatures for the period of time may be used. In an alternate embodiment, the temperatures for a past period of time may be averaged to estimate the temperatures over the period of time. For example, to estimate the temperature for a day in November, the temperatures on the same day for the past three years may be averaged. Table 15 illustrates examples of daily temperatures inside a print shop for the month of November for a print shop located in Minneapolis, Minn. according to an embodiment.

TABLE 15

| | Inside |
|---|---|
| November | Temp (° F.) |
| 1 | 64 |
| 2 | 65 |
| 3 | 64 |
| 4 | 66 |
| 5 | 65 |
| 6 | 65 |
| 7 | 66 |
| 8 | 65 |
| 9 | 67 |
| 10 | 66 |
| 11 | 67 |
| 12 | 68 |
| 13 | 67 |
| 14 | 66 |
| 15 | 66 |
| 16 | 67 |
| 17 | 65 |
| 18 | 68 |
| 19 | 67 |
| 20 | 66 |
| 21 | 64 |
| 22 | 65 |
| 23 | 66 |
| 24 | 65 |
| 25 | 65 |
| 26 | 67 |
| 27 | 66 |
| 28 | 67 |
| 29 | 65 |
| 30 | 66 |

In an embodiment, a heat loss rate for a period of time may be determined 545. For example, a heat loss rate for each day in the time period of interest may be determined. In an embodiment, a heat loss rate may be determined using the formula described above. For example, an estimate of the heat loss rate of the print shop illustrated in FIG. 5A on November 16, may be represented by the following:

$$P = ( \frac{{A}_{1}}{{R}_{1}} + \frac{{A}_{2}}{{R}_{2}} + … \frac{{A}_{n}}{{R}_{n}} ) * Δ t , where$$

$$\begin{matrix}P = ( \frac{8750}{12.05} + \frac{7000}{10.83} + \frac{8750}{12.02} + \frac{7000}{10.90} ) * ( 67 - 35 ) \\ = ( 726.14 + 646.35 + 727.95 + 642.20 ) * 32 \\ = 87 , 764.48 BTU \text{/} day\end{matrix}$$

Referring back to FIG. 3, in an embodiment, a total heat generation value over the period of time may be reduced by the heat loss rate to determine 325 a net heat emission value. For example, as illustrated by Table 14, on November 16, the total heat generation value is 135,887.60 BTU. The heat loss rate during the period (i.e., 87,764.48 BTU) may be subtracted from the total heat generation value of 135,887.60 BTU to produce a net heat emission value of 48,123.12 BTU.

In an embodiment, a net heat emission value may be compared to the total heat generation value to classify 330 the net heat emission value. For example, a net heat emission value may be classified 330 as beneficial, inexpensive-to-mitigate or expensive-to-mitigate. In an embodiment, a classification associated with a net heat emission value may depend on whether the time period occurs during a heating season or a cooling season, the print shop's location and/or the like.

In an embodiment, if the time period occurs during a heating season, a net heat emission value may be classified as beneficial if the net heat emission value is less than a heat demand value associated with the print shop during the time period. In an embodiment, the amount of heat required by a furnace of the print shop may be reduced by the net heat emission value.

In an embodiment, a heat demand value may be an amount of heat needed to sufficiently heat the print shop during the time period. In an embodiment, a heat demand value may be based on one or more historical values. For example, a heat demand value for November 16 may be based on heat demand values associated with November 16 for the print shop in one or more previous years. For instance, a heat demand value may be the average of the heat demand values over the period of time for the previous three years. Additional and/or alternate computations may be used within the scope of this disclosure. Referring to the above example, if a heat demand value for November 16 is 50,000 BTU and the net heat emission value is 48,123.12 BTU, then the net heat emission value may be classified 330 as beneficial. In an embodiment, a heat demand value may be stored in a database and/or another computer-readable storage medium.

In an embodiment, a heating season may be a period of time during which a print shop operates its heat. A heating season may be specific to a location associated with a print shop. For example, a heating season associated with a print shop located in Anchorage, Ak. may be different than a heating season associated with a print shop located in Charlotte, N.C.

In an embodiment, a net heat emission value may be classified 330 as inexpensive-to-mitigate if, during a heating season, the net heat emission value exceeds a heat demand value for a print shop. In this situation, the print shop's furnaces will not need to generate heat as the print shop generates a sufficient amount of heat to heat the print shop.

In an embodiment, a net heat emission value may be classified 330 as expensive-to-mitigate if the net heat emission value is generated during a cooling season associated with the print shop. In an embodiment, a cooling season may be a period of time during which a print shop operates its air conditioning.

A heating season may be specific to a location associated with a print shop. For example, a cooling season associated with a print shop located in Minneapolis, Minn. may be different than a cooling season associated with a print shop located in Miami, Fla.

In an embodiment, an amount of air conditioning needed to mitigate the expensive-to-mitigate net heat emission values may be determined 335. In an embodiment, an amount of air conditioning needed may be determined based on a conversion metric. For example, 1 ton of air conditioning per hour may be required to mitigate 12,000 BTUs per hour. In an embodiment, an amount of air conditioning may be determined 335 by dividing a net heat emission value by a conversion metric. For example, 5 tons of air conditioning per hour may be needed to mitigate 60,000 BTUs of heat per hour (i.e., 60,000 BTUs/12,000 BTUs).

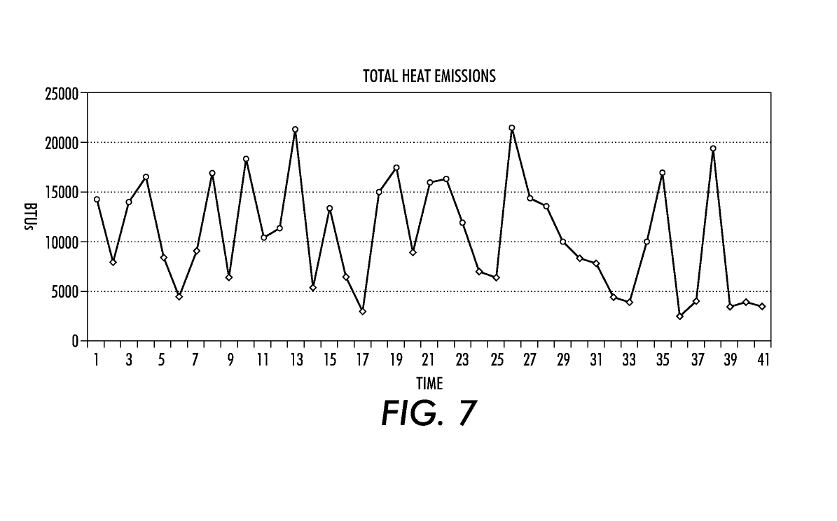

In an embodiment, one or more reports may be generated 340 showing the classification of net heat emission values over a period of time, an amount of air conditioning needed to mitigate expensive-to-mitigate net heat emission values over a period of time and/or the like. In an embodiment, the report may include one or more charts, graphs, images, pictures and/or the like. For example, a report may include a graph similar to those depicted in FIGS. 7, 8 and/or 9.

FIG. 7 illustrates a graph showing beneficial and inexpensive-to-mitigate net heat emission values associated with a print shop in Minneapolis over a period of time according to an embodiment. The circular dots represent the beneficial net heat emission values, and the square dots represent the inexpensive-to-mitigate net heat emission values according to an embodiment.

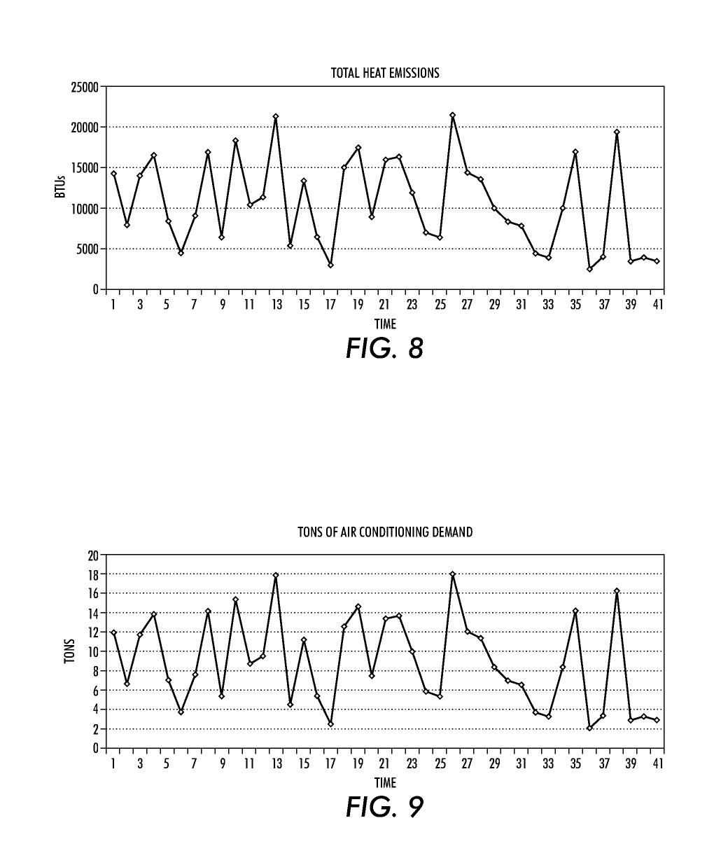

FIG. 8 illustrates a graph showing expensive-to-mitigate net heat emission values associated with a print shop in Miami over a period of time according to an embodiment. FIG. 9 illustrates a graph showing the air conditioning demand associated with mitigating the expensive-to-mitigate net heat emission values associated with a print shop in Miami illustrated in FIG. 8.

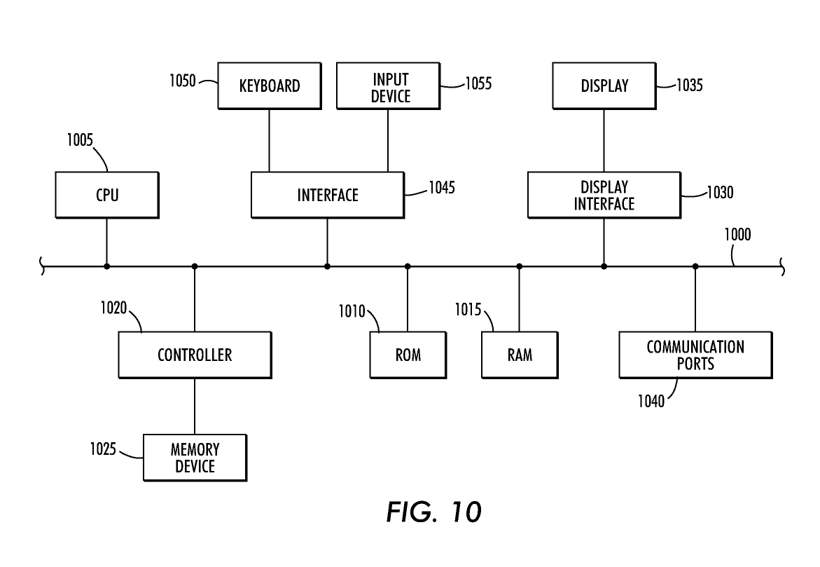

FIG. 10 depicts a block diagram of internal hardware that may be used to contain or implement program instructions according to an embodiment. A bus 1000 serves as the main information highway interconnecting the other illustrated components of the hardware. CPU 1005 is the central processing unit of the system, performing calculations and logic operations required to execute a program. Read only memory (ROM) 1010 and random access memory (RAM) 1015 constitute exemplary memory devices.

A controller 1020 interfaces with one or more optional memory devices 1025 to the system bus 1000. These memory devices 1025 may include, for example, an external or internal DVD drive, a CD ROM drive, a hard drive, flash memory, a USB drive or the like. As indicated previously, these various drives and controllers are optional devices.

Program instructions may be stored in the ROM 1010 and/or the RAM 1015. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 1030 may permit information from the bus 1000 to be displayed on the display 1035 in audio, visual, graphic or alphanumeric format. Communication with external devices may occur using various communication ports 1040. An exemplary communication port 1040 may be attached to a communications network, such as the Internet or an intranet.

The hardware may also include an interface 1045 which allows for receipt of data from input devices such as a keyboard 1050 or other input device 1055 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of estimating heat emissions for a print shop, the method comprising:
determining a total heat generation value associated with a print shop over the period of time by summing a non-print production heat generation value associated with the print shop over the period of time and a print production heat generation value associated with the print shop over the period of time;
determining, by a computing device, a net heat emission value associated with the print shop over the period of time by reducing the total heat generation value by a heat loss rate; and
displaying one or more of the non-print production heat generation value, the print production heat generation value, the total heat generation value, and the net heat emission value.

2. The method of claim 1, further comprising determining the non-print production heat generation value by:
determining a first value equal to a total amount of heat generated by people in the print shop over the period of time;
determining a second value equal to a total amount of heat generated by light sources in the print shop over the period of time;
determining a third value equal to a total amount of heat generated by non-print devices in the print shop over the period of time; and
summing the first value, the second value and the third value.

3. The method of claim 1, further comprising determining a print production heat generation value associated with the print shop by:
for each of a plurality of print devices in the print shop:
determining a low-activity state heat generation value associated with the print device operating in one or more low-activity states over the period of time, and
determining a processing state heat generation value associated with the print device operating in a processing state over the period of time;
determining a print shop low-activity state heat generation value associated with the print shop by summing the low-activity state heat generation values associated with each print device in the plurality of print devices;
determining a print shop processing state heat generation value associated with the print shop by summing the processing state heat generation values associated with each print device in the plurality of print devices;
determining a print shop heat generation value by summing the print shop low-activity state heat generation value and the print shop processing state heat generation value.

4. The method of claim 3, wherein determining a low-activity state heat generation value associated with the print device comprises:
determining a low-activity state time associated with the print device, wherein the low-activity state time comprises an amount of time that the print device operates in a low-activity state over the period of time;
determining a low-activity state rate associated with the print device, wherein the low-activity state rate comprises a heat generation rate associated with the print device operating in the low-activity state over a second period of time;
determining a low-activity state heat generation value by multiplying the low-activity state time and the low-activity state rate.

5. The method of claim 4, wherein:
determining a low-activity state time comprises determining an amount of time the print device operates in one or more of the following:
idle mode,
sleep mode, and
off mode; and
determining a low-activity state rate comprises determining a heat emission rate associated with the print device operating in one or more of the following:
idle mode,
sleep mode, and
off mode.

6. The method of claim 3, wherein determining a processing state heat generation value associated with the print device comprises:
determining a processing time associated with the print device, wherein the processing time comprises an amount of time the print device processes one or more print jobs during the period of time;
determining a processing rate associated with the print device, wherein the processing state rate comprises a heat generation rate associated with the print device operating in a processing state over a second period of time;
multiplying the processing time by the processing rate.

7. The method of claim 6, wherein determining a processing time comprises:
identifying a print job to be processed by the print shop during the period of time;
identifying one or more batches associated with the print job, wherein each batch has a corresponding batch size;
for each batch assigned to the print device:
determining a batch processing time associated with processing the batch by dividing the batch size associated with the batch by the processing rate, and
summing the batch processing times.

8. The method of claim 1, wherein determining a heat loss rate comprises:
identifying one or more portions of the print shop;
for each identified portion, determining a ratio by dividing an area associated with the portion by a thermal resistance value associated with the portion;
determining a sum by summing the ratios associated with each identified portion;
estimating a temperature difference between an internal temperature associated with the print shop and an external temperature associated with the print shop; and
multiplying the sum by the temperature difference.

9. The method of claim 1, further comprising classifying the net heat emission value as beneficial, inexpensive-to-mitigate or expensive to mitigate.

10. The method of claim 9, wherein classifying the net heat emission value comprises:
in response to the time period occurring during a heating season associated with the print shop and the net heat emission value is less than a heat demand value associated with the print shop during the time period, classifying the net heat emission value as beneficial.

11. The method of claim 9, wherein classifying the net heat emission value comprises:
in response to the time period occurring during a heating season associated with the print shop and the net heat emission value is greater than a heat demand value associated with the print shop during the time period, classifying the net heat emission value as inexpensive-to-mitigate.

12. The method of claim 9, wherein classifying the net heat emission value comprises:
classifying the net heat emission value as expensive-to-mitigate in response to the time period occurring during a cooling season associated with the print shop.

13. The method of claim 12, further comprising:
determining an amount of air conditioning needed to mitigate the net heat emission value by dividing the net heat emission value by a conversion metric representing a ratio of an amount of air conditioning to an amount of heat emission.

14. The method of claim 13, wherein displaying comprises displaying the amount of air conditioning needed to mitigate the net heat emission value.

15. A system for estimating heat emissions for a print shop, the system comprising:
a computing device; and
a computer-readable storage medium in communication with the computing device, wherein the computer-readable storage medium comprises one or more programming instructions that, when executed, cause the computing device to:
determine a total heat generation value associated with a print shop over the period of time by summing a non-print production heat generation value associated with the print shop over the period of time and a print production heat generation value associated with the print shop over the period of time,
determine a net heat emission value associated with the print shop over the period of time by reducing the total heat generation value by a heat loss rate, and
display one or more of the non-print production heat generation value, the print production heat generation value, the total heat generation value, and the net heat emission value.

16. The system of claim 15, wherein the one or more programming instructions further comprise one or more programming instructions that, when executed, cause the computing device to determine the non-print production heat generation value by:
determining a first value equal to a total amount of heat generated by people in the print shop over the period of time;
determining a second value equal to a total amount of heat generated by light sources in the print shop over the period of time;
determining a third value equal to a total amount of heat generated by non-print devices in the print shop over the period of time; and
summing the first value, the second value and the third value.

17. The system of claim 15, further wherein the one or more programming instructions further comprise one or more programming instructions that, when executed, cause the computing device to determine a print production heat generation value associated with the print shop by:
for each of a plurality of print devices in the print shop:
determining a low-activity state heat generation value associated with the print device operating in one or more low-activity states over the period of time, and
determining a processing state heat generation value associated with the print device operating in a processing state over the period of time;
determining a print shop low-activity state heat generation value associated with the print shop by summing the low-activity state heat generation values associated with each print device in the plurality of print devices;
determining a print shop processing state heat generation value associated with the print shop by summing the processing state heat generation values associated with each print device in the plurality of print devices;
determining a print shop heat generation value by summing the print shop low-activity state heat generation value and the print shop processing state heat generation value.

18. The system of claim 17, wherein the one or more programming instruction for determining a low-activity state heat generation value associated with the print device comprise one or more programming instructions that, when executed, cause the computing device to:
determine a low-activity state time associated with the print device, wherein the low-activity state time comprises an amount of time that the print device operates in a low-activity state over the period of time;
determine a low-activity state rate associated with the print device, wherein the low-activity state rate comprises a heat generation rate associated with the print device operating in the low-activity state over a second period of time; and
determine a low-activity state heat generation value by multiplying the low-activity state time and the low-activity state rate.

19. The system of claim 17, wherein the one or more programming instructions for determining a processing state heat generation value associated with the print device comprise one or more programming instructions that, when executed, cause the computing device to:
determine a processing time associated with the print device, wherein the processing time comprises an amount of time the print device processes one or more print jobs during the period of time;
determine a processing rate associated with the print device, wherein the processing state rate comprises a heat generation rate associated with the print device operating in a processing state over a second period of time; and
multiply the processing time by the processing rate.

20. The system of claim 19, wherein the one or more programming instructions for determining a processing time comprise one or more programming instructions that, when executed cause the computing device to:
identify a print job to be processed by the print shop during the period of time;
identify one or more batches associated with the print job, wherein each batch has a corresponding batch size;
for each batch assigned to the print device:
determine a batch processing time associated with processing the batch by dividing the batch size associated with the batch by the processing rate, and
sum the batch processing times.

21. The system of claim 15, wherein the one or more programming instructions for determining a heat loss rate comprise one or more programming instructions that, when executed cause the computing device to:
identify one or more portions of the print shop;
for each identified portion, determine a ratio by dividing an area associated with the portion by a thermal resistance value associated with the portion;
determine a sum by summing the ratios associated with each identified portion;
estimate a temperature difference between an internal temperature associated with the print shop and an external temperature associated with the print shop; and
multiply the sum by the temperature difference.

22. The system of claim 15, wherein the one or more programming instructions further comprise one or more programming instructions that, when executed, cause the computing device to classify the net heat emission value as expensive-to-mitigate in response to the time period occurring during a cooling season associated with the print shop.

23. The system of claim 22, wherein the one or more programming instructions further comprise one or more programming instructions that, when executed, cause the computing device to determine an amount of air conditioning needed to mitigate the net heat emission value by dividing the net heat emission value by a conversion metric representing a ratio of an amount of air conditioning to an amount of heat emission.
